(19) United States
(12) Patent Application Publication
(10) Pub. No.: US 2024/0419267 A1
(43) Pub. Date: Dec. 19, 2024

(54) INPUT DEVICE

(71) Applicant: PFU LIMITED, Kahoku-shi (JP)

(72) Inventors: Satoshi Kubota, Kahoku-shi (JP); Sota Matsuura, Kahoku-shi (JP)

(21) Appl. No.: 18/733,528

(22) Filed: Jun. 4, 2024

(30) Foreign Application Priority Data
Jun. 14, 2023 (JP) 2023-097948

(51) Int. Cl. G06F 3/0354; G06F 3/01; G06F 3/02; G06F 3/038

(52) U.S. Cl. CPC G06F 3/03547; G06F 3/0213; G06F 3/038; G06F 3/016

(57) ABSTRACT

An input device includes a housing, a touch pad, and a guide portion. The touch pad is disposed on at least one of a right side surface, a left side surface, a front side surface, and a rear side surface of the housing along the at least one side surface. The guide portion is disposed on the at least one side surface. The guide portion is located below the touch pad. The guide portion extends along the at least one side surface. The guide portion protrudes outward relative to the touch pad.

### CROSS-REFERENCE TO RELATED APPLICATION

This patent application is based on and claims priority pursuant to 35 U.S.C. § 119 (a) to Japanese Patent Application No. 2023-097948, filed on Jun. 14, 2023, in the Japan Patent Office, the entire disclosure of which is hereby incorporated by reference herein.

### BACKGROUND

The present disclosure relates to an input device.

In recent years, input devices such as keyboards provided with a touch pad have been developed. There is a demand for such input devices to allow the user to intuitively grasp the location of the touch pad.

In the related art, for example, an in-vehicle information device includes a touch panel to detect a touch operation and a gesture operation and a liquid crystal panel in which the touch panel is stacked on a display screen, and controls a display image of the liquid crystal panel according to an operation performed on the touch panel.

In another example, an input-assistance-means operation device includes a first-direction-position operation input section to operate a position of a mouse pointer as an input assistance means in a first direction of a display screen of an electronic information apparatus. The first-direction-position operation input section is disposed in a first edge part formed by intersection of an operation surface and a side surface of an operation-device housing.

In another example, a point input device includes a built-in switch to sense a pressing operation and an edge that has no sensing mechanism and is disposed one step higher around a sensing portion of a point input unit of the point input device. This point input device can sense only a pressing operation without changing a point by pressing only the edge.

### SUMMARY

An input device according to one aspect of the present disclosure includes a housing, a touch pad, and a guide portion. The touch pad is disposed on at least one of a right side surface, a left side surface, a front side surface, and a rear side surface of the housing along the at least one side surface. The guide portion is disposed on the at least one side surface. The guide portion is located below the touch pad. The guide portion extends along the at least one side surface. The guide portion protrudes outward relative to the touch pad.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an input device according to an embodiment;

FIG. 2 is a top view of the input device;

FIG. 3 is a right side view of the input device;

FIG. 4 is a front side view of the input device;

FIG. 5 is a back side view of the input device;

FIG. 6 is an A-A line cross-sectional view of a touch pad and a guide portion illustrated in FIG. 2;

FIG. 7 is a block diagram illustrating a schematic configuration of the input device;

FIGS. 8A, 8B, and 8C are schematic diagrams illustrating an input device according to another embodiment;

FIGS. 9A and 9B are schematic diagrams illustrating an input device according to another embodiment;

FIG. 10 is a schematic diagram illustrating an input device according to another embodiment;

FIG. 11 is a schematic diagram illustrating an input device according to another embodiment; and

FIG. 12 is a schematic diagram illustrating an input device according to another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an input device according to an embodiment of the present disclosure, with reference to the drawings. The technical scope of the present disclosure, however, is not limited to the embodiments described below but includes the scope of the appended claims and the equivalents thereof.

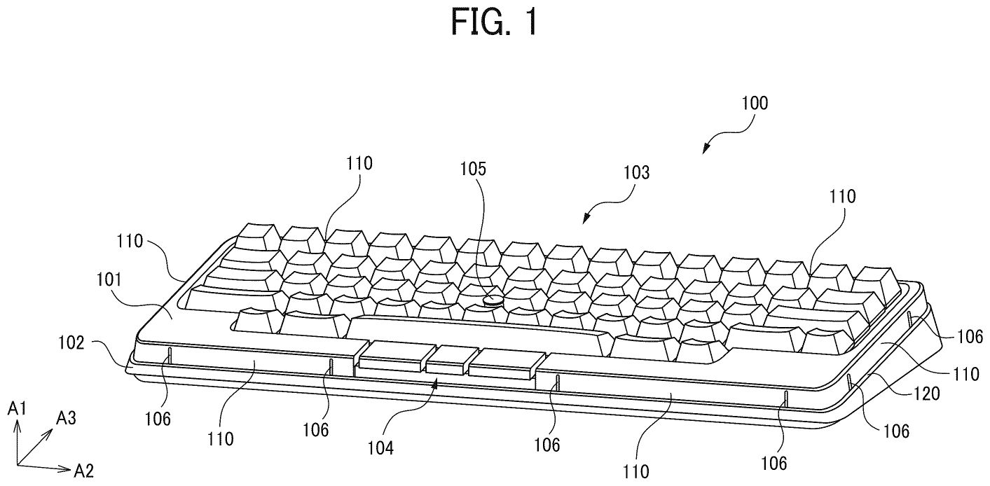

FIG. 1 is a perspective view of an input device 100 according to the present embodiment.

In FIG. 1, arrow A1 indicates a substantially vertical direction (a height direction of the input device 100), arrow A2 indicates a longitudinal direction (a widthwise direction) of the input device 100 that is orthogonal to the height direction, and arrow A3 indicates a lateral direction (a depth direction) of the input device 100 that is orthogonal to the height direction and the widthwise direction.

The input device 100 receives an input operation from a user, and outputs an operation signal according to the user's input operation to an information processing apparatus (e.g., a personal computer or a portable information terminal) electrically connected to the input device 100. FIG. 1 illustrates a keyboard as an example of the input device 100. The input device 100 includes a first housing 101 and a second housing 102. The first housing 101 and the second housing 102 are an example of housings. The second housing 102 is disposed below the first housing 101. The input device 100 includes multiple keys 103, multiple buttons 104, a pointing device 105, and multiple touch pads 110. The keys 103, the buttons 104, the pointing device 105, and the touch pads 110 are all disposed on the first housing 101.

The keys 103 are used for inputting characters, alphanumeric characters, symbols, etc. The buttons 104 can be assigned with the same functions as those of a left button, a right button, and a wheel button of a typical three button mouse. Other functions commonly used in input devices may be assigned to the keys 103. The pointing device 105 is used to specify an input position or coordinates on a screen of a display device included in an information processing apparatus to which the input device 100 is connected.

The touch pads 110 can be assigned with gesture functions and output signals corresponding to operations such as touch, double touch, press, long press, swipe, and pinch. The touch pads 110 are used to vertically or horizontally scroll, rotate, enlarge, or reduce a screen of a display device of an information processing apparatus to which the input device 100 is connected. Examples of an object to be rotated by the touch pads 110 include an object selected on the screen.

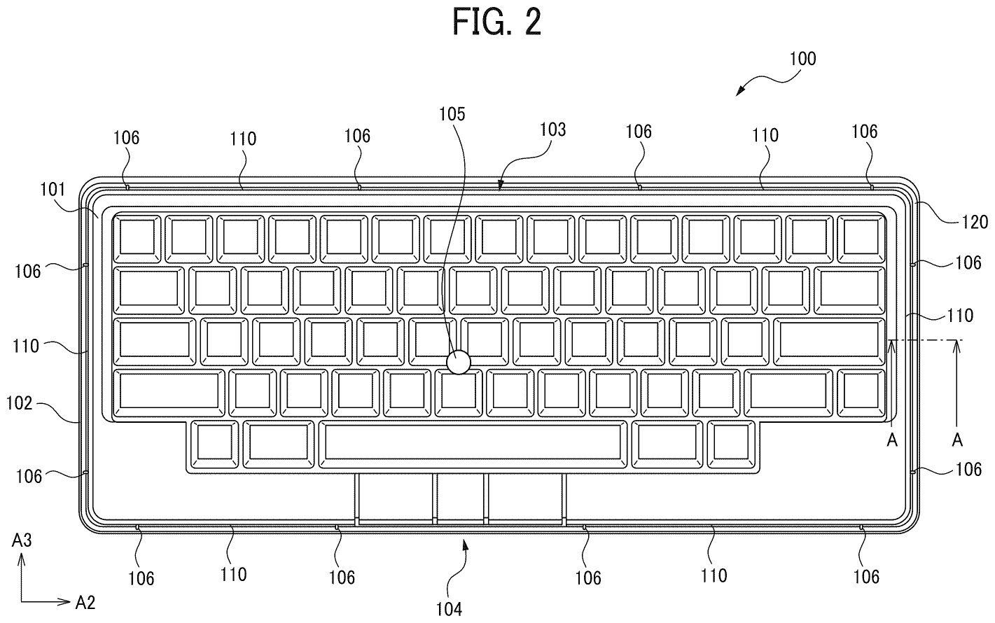

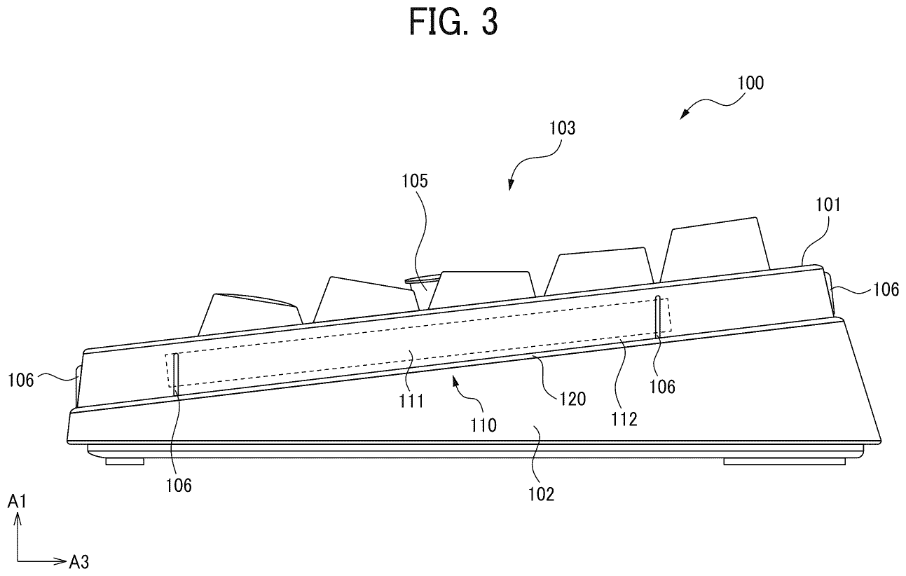

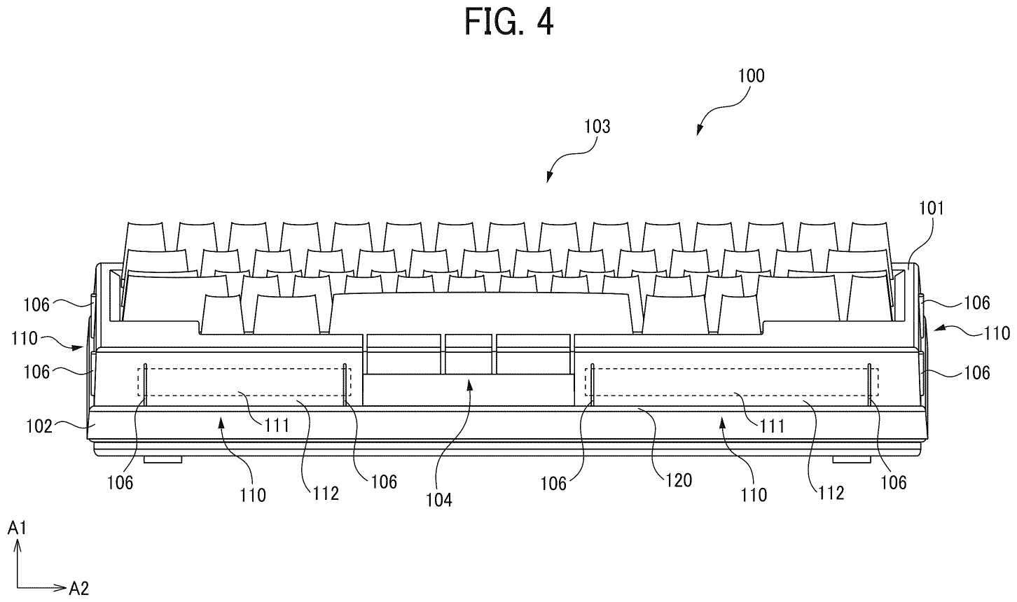

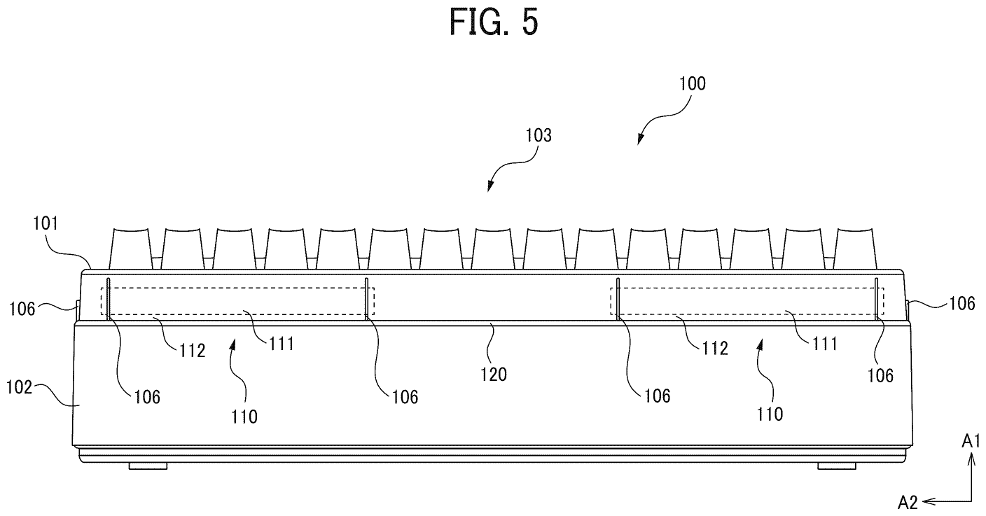

FIG. 2 is a top view of the input device 100, FIG. 3 is a right side view of the input device 100, FIG. 4 is a front side view of the input device 100, and FIG. 5 is a back side view of the input device 100. The shape of the left side surface of the input device 100 is bilaterally symmetrical with the shape of the right side surface illustrated in FIG. 3.

As illustrated in FIGS. 1 to 5, the keys 103 are disposed on a top surface of the first housing 101. The buttons 104 are disposed to span from the top surface to the front side surface of the first housing 101. Like the keys 103, the pointing device 105 is disposed on the top surface of the first housing 101. The position of the pointing device 105 is laid out based on the positions of the buttons 104 in consideration of being operated together with the buttons 104. For example, the pointing device 105 is disposed at a position overlapping a button 104 when viewed from the longitudinal direction.

The touch pads 110 are disposed on the right side surface, the left side surface, the front side surface, and the rear side surface of the first housing 101 along each side surface. In the present embodiment, one touch pad 110 is disposed on each of the right side surface and the left side surface of the first housing 101, and two touch pads 110 are disposed on each of the front side surface and the rear side surface of the first housing 101 such that the two touch pads 110 are separated and located on the left and right sides. The touch pad 110 includes a touch sensor 111 and a cover 112.

The touch sensor 111 is a sensor that detects a user's touch. The touch sensors 111 are disposed inside the right side surface, the left side surface, the front side surface, and the rear side surface of the first housing 101 along each side surface.

The cover 112 is disposed to cover the touch sensor 111. In the present embodiment, the cover 112 of the touch sensor 111 also serves as the cover of the first housing 101. The cover 112 of the touch sensor 111 may be disposed separately from the cover of the first housing 101. The cover 112 is provided with protrusions 106. As illustrated in FIGS. 1 to 5, the protrusions 106 are located inside the positions facing the ends of the touch sensor 111 in the extending direction of the touch pad 110. The protrusions 106 disposed on the cover 112 allows the user to intuitively understand the location of the touch sensor 111 disposed inside the cover 112, that is, an operation region of the touch pad 110, and reliably operate the touch pad 110. In addition, even in a case where the operation region of the touch pad 110 is divided into two, the protrusions 106 disposed on the cover 112 allows the user to intuitively understand the operation region of each touch pad 110 and reliably operate each touch pad 110.

The touch pad 110 may be disposed on at least one side surface of the first housing 101 rather than on all of the right side surface, the left side surface, the front side surface, and the rear side surface. Furthermore, the protrusion 106 may be located at a position facing an end of the touch sensor 111, instead of inside the position facing the end of the touch sensor 111. Instead of the protrusion 106, the cover 112 may be provided with a recess that is recessed toward the touch sensor 111. In these cases as well, the user can intuitively understand the operation region of the touch pad 110 on the cover 112 and can reliably operate the touch pad 110. Alternatively, the protrusion 106 may be omitted.

Guide portions 120 are disposed on the right side surface, the left side surface, the front side surface, and the rear side surface of the second housing 102, that is, the right side surface, the left side surface, the front side surface, and the rear side surface of the input device 100 on which the touch pad 110 is disposed. As illustrated in FIGS. 1 to 5, the guide portion 120 is located below the touch pad 110 to extend along each side surface provided with the touch pad 110 and protrude outward relative to the touch pad 110.

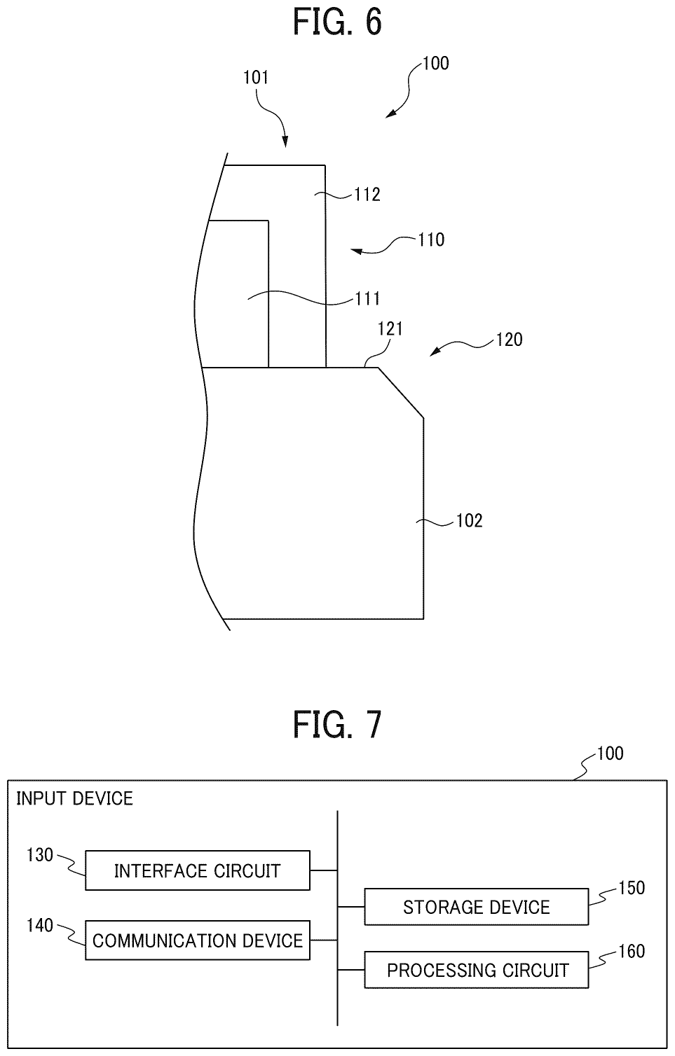

FIG. 6 is an A-A line cross-sectional view of the touch pad 110 and the guide portion 120 illustrated in FIG. 2.

As illustrated in FIG. 6, the guide portion 120 includes a flat part 121 that extends from the side surface of the first housing 101 provided with the touch pad 110 so as to be substantially orthogonal to the height direction A1, that is, to be substantially parallel to the bottom surface of the input device 100. The user can intuitively understand the location of the touch pad 110 by touching the flat part 121, and can reliably operate the touch pad 110. The user can accurately operate the touch pad 110 without viewing the touch pad 110, and the input device 100 can enhance user convenience.

Further, the guide portion 120 has a chamfered shape. In the present embodiment, the guide portion 120 has a C-chamfered (tapered) shape at its corners. The guide portion 120 may have an R-chamfered shape (roundness) at its corners. Thus, the guide portion 120 is less likely to be caught when the user operates the touch pad 110. The user can smoothly move a finger while touching the touch pad 110, and the input device 100 can enhance user's operability.

The guide portion 120 is disposed to protrude by 0.1 mm or more from each side surface of the first housing 101 provided with the touch pad 110. Preferably, the guide portion 120 is disposed to protrude by 0.2 mm or more from each side surface of the first housing 101 provided with the touch pad 110. More preferably, the guide portion 120 is disposed to protrude by 1.0 mm or more from each side surface of the first housing 101 provided with the touch pad 110.

In an experiment in which users operate the touch pad 110 while varying the amount of protrusion of the guide portion 120, when the guide portion 120 is protruded by 0.1 mm or more, 90% or more of the users could understand the location of the touch pad 110. Therefore, since the guide portion 120 is disposed to protrude by 0.1 mm or more, the user can understand the location of the touch pad 110 and can appropriately operate the touch pad 110. Furthermore, it is indicated that a human finger of 0.2 mm or more can be recognized as a sensation in “http://www.files.tachilab.org/publications/paper2000/shinmeimae200803TVRSJ.pdf”. Therefore, since the guide portion 120 is disposed to protrude by 0.2 mm or more, the user can reliably recognize the guide portion 120 and can appropriately operate the touch pad 110.

In addition, in the experiment described above, when the guide portion 120 is protruded by 1.0 mm or more, all users could understand the location of the touch pad 110. Therefore, since the guide portion 120 is disposed to protrude by 1.0 mm or more, the user can more reliably recognize the location of the touch pad 110 and can more reliably operate the touch pad 110.

Note that the guide portion 120 is disposed as a single piece along the periphery of the second housing 102, but may be disposed separately in correspondence with each of the touch pads 110. Further, the guide portion 120 may not have a chamfered shape.

FIG. 7 is a block diagram illustrating a schematic configuration of the input device 100. The input device 100 further includes an interface circuit 130, a communication device 140, a storage device 150, and a processing circuit 160 in addition to the components described above.

The interface circuit 130 acquires operation signals corresponding to user's input operations output from the keys 103, the buttons 104, the pointing device 105, and the touch pads 110, and transmits the operation signals to the processing circuit 160.

The communication device 140 includes an antenna that transmits and receives wireless signals, and a wireless communication interface circuit for transmitting and receiving signals to and from an information processing apparatus via a wireless communication line in accordance with a predetermined communication protocol. The predetermined communication protocol is a wireless communication protocol using, for example, BLUETOOTH or IEEE 802.15. Instead of the communication device 140, the input device 100 may include an interface circuit compliant with, for example, a serial bus such as a universal serial bus (USB) and may be connected to an information processing apparatus by a wire to transmit and receive signals.

The storage device 150 includes, for example, a memory device such as a random-access memory (RAM) and a read-only memory (ROM). The storage device 150 stores computer programs, databases, tables, and other data used for various types of processing by the input device 100. The computer programs may be installed in the storage device 150 from a computer-readable portable recording medium using, for example, a known setup program. The portable recording medium is, for example, a compact disc read-only memory (CD-ROM) or a digital versatile disc read-only memory (DVD-ROM). The computer program may be distributed from a server or other device and installed in the storage device 150.

The processing circuit 160 operates in accordance with a program prestored in the storage device 150. The processing circuit 160 is, for example, a central processing unit (CPU). As the processing circuit 160, for example, a digital signal processor (DSP), a large scale integration (LSI), an application-specific integrated circuit (ASIC), or a field-programmable gate array (FPGA) may be used. The processing circuit 160 is connected to the interface circuit 130, the communication device 140, the storage device 150, etc., and controls each of these circuit and devices. The processing circuit 160 acquires operation signals from each of the keys 103, the buttons 104, the pointing device 105, and the touch pads 110 via the interface circuit 130. The processing circuit 160 converts the acquired operation signal into an electric signal that can be output from the communication device 140 and processed by the information processing apparatus, and transmits the electric signal to the information processing apparatus via the communication device 140.

In the input device 100, as described in detail above, the touch pad 110 is disposed on a side surface of the input device 100, and the guide portion 120 that protrudes outward relative to the touch pad 110 is located below the touch pad 110. Thus, the user can intuitively understand the location of the touch pad 110, and the input device 100 can enhance user convenience.

Further, the touch pad 110 disposed on the side surface of the input device 100 allows the size of the entire input device to be smaller than in a case where a touch pad is disposed on the same surface as a surface on which multiple keys are disposed as in, for example, an input device disposed in a laptop personal computer (PC). The touch pad 110 disposed on the side surface of the input device 100 can also prevent the user from erroneously contacting and operating the touch pad 110 while the user is typing on the keys 103. Since the entire side surface of the input device 100 can be the area where the touch pad 110 can be installed, the limitation on the structure of the touch pad 110 can be reduced.

Since the guide portion 120 located below the touch pad 110 serves as a guide for understanding the location and the operation region of the touch pad 110, the user can clearly understand the location and the operation region of the touch pad 110 and can move a finger along the guide portion 120. Even when multiple touch pads 110 are disposed, the user can clearly understand the locations of the touch pads 110 by the guide portion 120.

In addition, since the touch pad 110 and the guide portion 120 are disposed to extend along each side surface, the user can accurately operate the touch pad 110 while touching the guide portion 120 without visual confirmation. Furthermore, the user can accurately operate the touch pad 110 even if there are no irregularities or clear marks on the operation region of the touch pad 110.

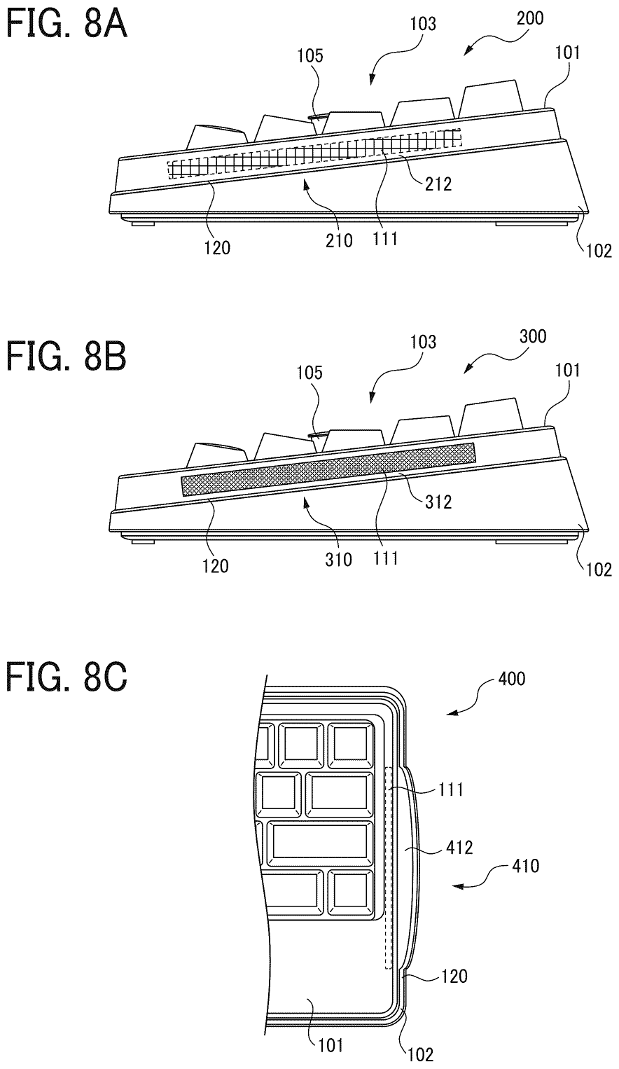

FIG. 8A is a schematic diagram illustrating an input device 200 according to another embodiment.

As illustrated in FIG. 8A, the input device 200 includes the components of the input device 100. However, the input device 200 does not include the protrusion 106 and includes a touch pad 210 instead of the touch pad 110. The touch pad 210 includes the components of the touch pad 110. However, the touch pad 210 includes a cover 212 instead of the cover 112. In the cover 212, a region facing the touch sensor 111 and a region not facing the touch sensor 111 are formed of different materials. For example, the region facing the touch sensor 111 is formed of a glass material or a metal material, and the region not facing the touch sensor 111 is formed of resin such as acrylonitrile butadiene styrene (ABS) resin or polybutylene terephthalate (PBT) resin. The region not facing the touch sensor 111 may be formed of the same or similar material as the housing of the input device 200 except for the cover 212. Plastic, an aluminum seal, a glass film, a polypropylene (PP) film, or an unevenly processed sheet may be attached to the region facing the touch sensor 111. The region facing the touch sensor 111 may be embossed. A texture may be formed in the region facing the touch sensor 111. The region facing the touch sensor 111 may be processed to be roughened (to have a rough skin touch). Since the region facing the touch sensor 111 and the region not facing the touch sensor 111 are formed of different materials, the respective regions are felt different from each other, and the user can intuitively understand the operation region of the touch pad 110. In addition, the material of the region facing the touch sensor 111 may be made changeable such that the user can customize the material of the operation region of the touch pad 210 to the user's preference.

FIG. 8B is a schematic diagram illustrating an input device 300 according to another embodiment.

As illustrated in FIG. 8B, the input device 300 includes the components of the input device 100. However, the input device 300 does not include the protrusion 106 and includes a touch pad 310 instead of the touch pad 110. The touch pad 310 includes the components of the touch pad 110. However, the touch pad 310 includes a cover 312 instead of the cover 112. In the cover 312, a region facing the touch sensor 111 and a region not facing the touch sensor 111 have different colors from each other. For example, the color of the region facing the touch sensor 111 is gray and the color of the region not facing the touch sensor 111 is white. The region facing the touch sensor 111 and the region not facing the touch sensor 111 have different colors from each other, so that the user can visually recognize the operation region of the touch pad 310.

FIG. 8C is a schematic diagram illustrating an input device 400 according to another embodiment.

As illustrated in FIG. 8C, the input device 400 includes the components of the input device 100. However, the input device 400 does not include the protrusion 106 and includes a touch pad 410 instead of the touch pad 110. The touch pad 410 includes the components of the touch pad 110. However, the touch pad 410 includes a cover 412 instead of the cover 112. In the cover 412, a region facing the touch sensor 111 and a region not facing the touch sensor 111 have different shapes from each other. For example, the region facing the touch sensor 111 has an arch shape and the region not facing the touch sensor 111 has a planar shape. Since the region facing the touch sensor 111 and the region not facing the touch sensor 111 have different shapes from each other, the user can feel the difference in unevenness and intuitively understand the position of the operation region of the touch pad 410 when the user touches the operation region of the touch pad 410.

The region facing the touch sensor 111 and the region not facing the touch sensor 111 may have surface shapes different from each other. For example, the surface shape of the region facing the touch sensor 111 is formed to be uneven, and the surface shape of the region not facing the touch sensor 111 is formed to be flat. The user can intuitively understand the position of the operation region of the touch pad 410 based on whether uneven shapes are felt when the user touches the operation region of the touch pad 410.

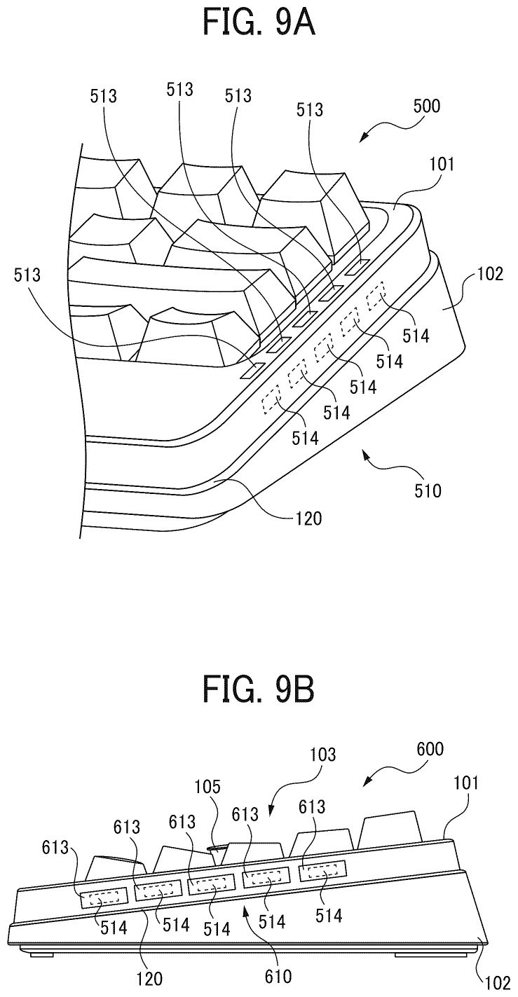

FIG. 9A is a schematic diagram illustrating an input device 500 according to another embodiment.

As illustrated in FIG. 9A, an input device 500 includes the components of the input device 100. However, the input device 500 does not include the protrusion 106 and includes a touch pad 510 instead of the touch pad 110. The touch pad 510 includes light emitters 513 and vibrators 514 in addition to the touch sensor 111 and the cover 112.

The light emitter 513 is, for example, a light emitting diode (LED). The light emitters 513 are disposed on the top surface of the first housing 101 along the direction in which each touch pad 510 extends. Note that the number of light emitters 513 may be one.

The processing circuit 160 detects a touch operation at each position of the touch pad 510 and turns on the light emitter 513 disposed at the position where the touch operation is detected. Thus, the user can understand that the touch pad 510 is properly operated and can intuitively understand which position of the touch pad 510 the user is touching.

The processing circuit 160 turns on the light emitter 513 when detecting a touch operation on the touch pad 510. Thus, the user can understand that the touch pad 510 is properly operated.

The vibrator 514 is, for example, a vibration motor. The vibrators 514 are disposed inside the right side surface, the left side surface, the front side surface, and the rear side surface of the first housing 101 along each side surface. Note that the number of vibrators 514 may be one. The vibrators 514 are evenly arranged at equal intervals in an operation region of the touch pad 510. The processing circuit 160 detects a touch operation at each position of the touch pad 510, and causes the vibrator 514 disposed at the position where the touch operation is detected to vibrate in response to the detection of the touch operation as a trigger. Since the vibrators 514 are evenly arranged in the operation region of the touch pad 510, the vibrators 514 are present in any positions of the touch pad 510 touched by the user. Therefore, when the user touches the touch pad 510, the vibration of the vibrator 514 is transmitted to the user, and the user can more surely understand that the touch pad 510 is properly operated.

FIG. 9B is a schematic diagram illustrating an input device 600 according to another embodiment.

As illustrated in FIG. 9B, the input device 600 includes the components of the input device 500. However, the input device 600 includes a touch pad 610 instead of the touch pad 510. The touch pad 610 includes the components of the touch pad 510. However, the touch pad 610 includes light emitters 613 instead of the light emitters 513. The light emitters 613 may be disposed on the operation regions of the touch pad 610, that is, on the respective side surfaces of the first housing 101 on which the touch pad 610 is disposed.

Note that the processing circuit 160 may detect the type of touch operation at each position of the touch pad 510 or 610 and may turn on the light emitters 513 or 613 in a manner corresponding to the type of touch operation detected. For example, the processing circuit 160 changes the emission colors of the light emitters 513 or 613 in response to an operation such as touch, double touch, press, long press, swipe, or pinch described above. The user can recognize the type of operation detected by the input device 100 from the difference in the emission color of the light emitter 513, and can understand whether the operation of the touch pad 510 or 610 is correctly performed.

Further, the processing circuit 160 may detect the type of touch operation at each position of the touch pad 510 or 610 and cause the vibrator 514 to vibrate in a manner corresponding to the type of touch operation detected. For example, the processing circuit 160 changes the vibration pattern of the vibrator 514 in response to an operation such as the above-described long press, swipe, or pinch. The user can recognize the type of operation detected by the input device 100 from the difference in the vibration pattern of the vibrator 514, and can understand whether the operation of the touch pad 510 or 610 is correctly performed.

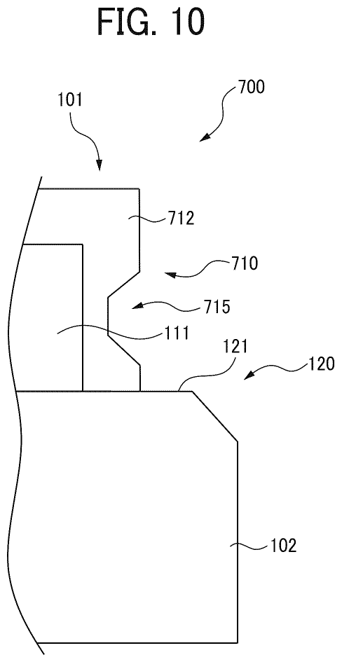

FIG. 10 is a schematic diagram illustrating an input device 700 according to another embodiment.

As illustrated in FIG. 10, the input device 700 includes the components of the input device 100. However, the input device 700 includes a touch pad 710 instead of the touch pad 110. The touch pad 710 includes the components of the touch pad 110. However, the touch pad 710 includes a cover 712 instead of the cover 112. A recess 715 that is recessed toward the touch sensor 111 is formed in a middle portion of the cover 712 in the height direction. Thus, the user can more clearly understand the position of the operation region of the touch pad 710.

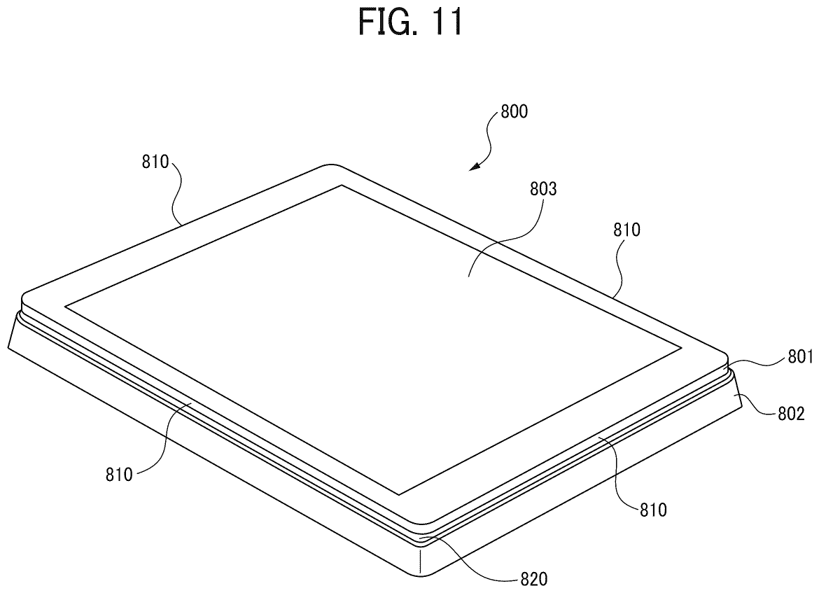

FIG. 11 is a schematic diagram illustrating an input device 800 according to another embodiment.

The input device 800 is a tablet terminal. As illustrated in FIG. 11, the input device 800 includes a first housing 801 and a second housing 802. The first housing 801 and the second housing 802 are an example of housings. A display device 803 that displays an operation screen is disposed on the top surface of the first housing 801. The display device 803 includes a liquid crystal display having a touch panel function, an interface circuit that outputs image data to a display, and an interface circuit that acquires an input signal from a touch panel, and displays image data on the display. Under the control of a processing circuit, the display device 803 displays an operation screen including a software keyboard, and outputs an operation signal according to a user's input operation to the processing circuit. The input device 800 does not include multiple keys on the top surface of the first housing 801. The input device 800 includes a touch pad 810 having a function similar to the touch pad 110 and a guide portion 820 having a function similar to the guide portion 120. The touch pad 810 is disposed on the right side surface, the left side surface, the front side surface, and the rear side surface of the first housing 801 along each side surface. The guide portion 820 is located below the touch pad 810 to extend along the side surface on which the touch pad 810 is disposed, and protrude outward relative to the touch pad 810. Note that the touch pad 810 may not be disposed on all of the right side surface, the left side surface, the front side surface, and the rear side surface of the first housing 801, and may be disposed on at least one side surface thereof.

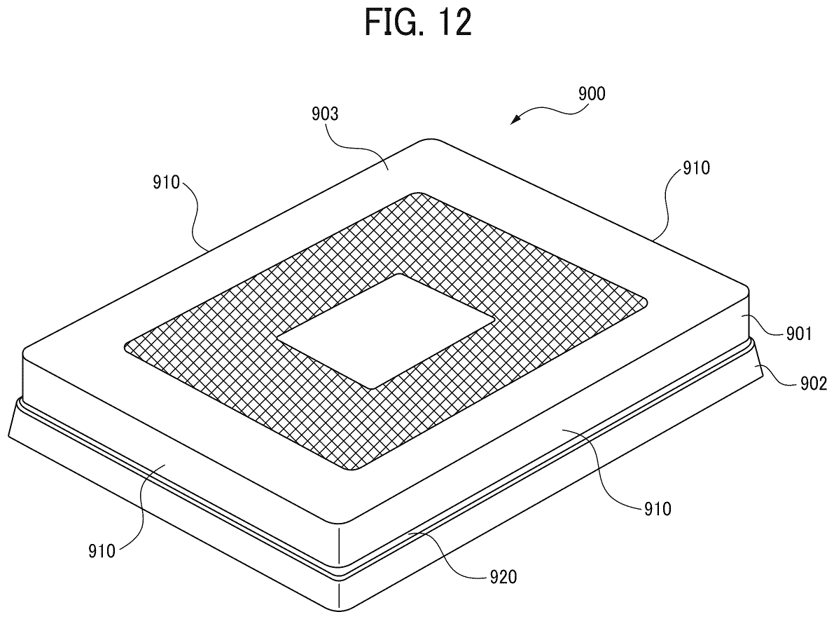

FIG. 12 is a schematic diagram illustrating an input device 900 according to another embodiment.

The input device 900 is a speaker. As illustrated in FIG. 12, the input device 900 includes a first housing 901 and a second housing 902. The first housing 901 and the second housing 902 are an example of housings. An audio output section 903 that outputs audio is disposed on the top surface of the first housing 901. The input device 900 does not include multiple keys on the top surface of the first housing 901. The input device 900 includes a touch pad 910 having a function similar to the touch pad 110 and a guide portion 920 having a function similar to the guide portion 120. The touch pad 910 is disposed on the right side surface, the left side surface, the front side surface, and the rear side surface of the first housing 901 along each side surface. The guide portion 920 is located below the touch pad 910 to extend along the side surface on which the touch pad 910 is disposed, and protrude outward relative to the touch pad 910. Note that the touch pad 910 may not be disposed on all of the right side surface, the left side surface, the front side surface, and the rear side surface of the first housing 901, and may be disposed on at least one side surface thereof.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An input device, comprising:
a housing;
a touch pad disposed on at least one of a right side surface, a left side surface, a front side surface, and a rear side surface of the housing along the at least one side surface; and
a guide portion disposed on the at least one side surface,
wherein the guide portion is located below the touch pad, extends along the at least one side surface, and protrudes outward relative to the touch pad.

2. The input device according to claim 1, further comprising a plurality of keys disposed on a top surface of the housing.

3. The input device according to claim 1,
wherein the guide portion has a chamfered shape.

4. The input device according to claim 1,
wherein the touch pad includes a touch sensor to detect a touch of a user and a cover covering the touch sensor, and
the cover has a protrusion or a recess at a position facing an end of the touch sensor or inside the position in a direction in which the touch pad extends.

5. The input device according to claim 1,
wherein the touch pad includes a touch sensor to detect a touch of a user and a cover covering the touch sensor, and
the cover includes a region facing the touch sensor and a region not facing the touch sensor that have different materials, colors, or shapes from each other.

6. The input device according to claim 1,
wherein the touch pad includes:
a touch sensor to detect a touch operation of a user; and
a light emitter or a vibrator, and
the input device further comprises circuitry configured to control the light emitter or the vibrator according to a touch position of the touch operation.

7. The input device according to claim 1,
wherein the touch pad includes:
a touch sensor to detect a touch operation of a user; and
a light emitter or a vibrator, and
the input device further comprises circuitry configured to control the light emitter or the vibrator according to a touch type of the touch operation.

8. The input device according to claim 1,
wherein the touch pad includes:
a touch sensor to detect a touch of a user and a cover covering the touch sensor; and
a recess formed in a middle portion of the cover in a height direction of the cover, the recess being recessed toward the touch sensor.
